(19) United States
(12) Patent Application Publication
(10) Pub. No.: US 2024/0414138 A1
(43) Pub. Date: Dec. 12, 2024

(54) System and Method for Secure Case Management Across at Least One Communication Network

(71) Applicant: Mahyar Okhovat, Sherman Oaks, CA (US)

(72) Inventor: Mahyar Okhovat, Sherman Oaks, CA (US)

(21) Appl. No.: 18/330,952

(22) Filed: Jun. 7, 2023

(51) Int. Cl. H04L 9/40; G06F 21/62

(52) U.S. Cl. CPC H04L 63/0428; G06F 21/6218

(57) ABSTRACT

A method and system are provided for secure case management across a communication network. Namely, the system allows for confidential communication and file-sharing across multiple computing devices. The method comprises creating a directory of users, receiving information relating to a case, creating the case from the information, and securely transmitting the case to the directory. The case may be securely transmitted by encrypting the case and allowing only permitted users in the directory to decrypt the case. The system may receive contributions associated with the case from the directory and transmit such contributions to the directory. Specific topics within the case may be divided into aspects and access to these aspects may be limited to less than all the users in the directory, to further protect the secure nature of the communication and files.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to case management, and more particularly, to systems and methods for securely sharing confidential files and information between select members of a directory.

### BACKGROUND

Vast avenues for communication cause inefficiencies that plague many across their personal or professional life. Indeed, ready access to smartphones that enable audio and text communication and even seemingly instantaneous data sharing and transfer across innumerable electronic applications and platforms has led some to experience an overwhelming number of messages, lost files, missing deadlines, and an altogether failure to convey information. The effects of inefficient communication range from trivial, such as reviewing the wrong version of a file, to devastating, such as missing a critical piece of information, event, or deadline. For example, failing to effectively communicate may cause papers in a lawsuit to not be timely filed, or pieces of evidence to be overlooked, potentially leading to the dismissal of the suit and costing the party significant sums. Even somewhat trivial communication errors, such as reviewing earlier versions of a file, may, in the aggregate, be significant as substantial time and money may be wasted.

A standard method of digital communication, especially for professionals, is, of course, email. While email allow multiple recipients to receive the same message and data files as attachments, it is inefficient and prone to communication mistakes. For instance, retaining recipient continuity requires all respondents to effectively “reply all,” and failure to do so at any point may cause problems when a recipient fails to effectively “reply all,” which may remove necessary, otherwise intended recipients without access to the information.

On the other hand, not all recipients need-or want-access to all information, and so it is not uncommon for numbers of unique email chains to be generated amongst various combinations of interested members for a single issue. In these instances, it can be easy to lose track of information and fail to inform the proper individuals.

In addition to the foregoing, email messages often become inundated with information and attachments, their importance ranging from relatively inconsequential but bloated signature blocks, to crucial evidence, and time-sensitive agreements. Without external systems in place to organize information contained in emails, it is easy to overlook or lose track of it. Thus, while emails may be useful, they are nevertheless deficient.

Some proposals have been made to improve communication. U.S. Publication No. 2018/0,350,019 to McLaren, for example, provides a medical system for health professionals to share patient information with other health professionals involved with the treatment of that patient. While this proposal may be suitable for keeping health professionals appraised of the patient's status, it does not provide the ability to share records with individuals outside the health network. Therefore, providing reports to a third party, such as a lawyer, must be performed through an alternative system, such as email. Thus, this proposal fails to provide a system to share information with professionals across multiple networks.

File-sharing systems across multiple networks has been proposed by some, such as U.S. Pat. No. 10,942,899 to Malhotra, however, these proposals are deficient to improve communication as they fail to integrate a case management system. Without the case management system, applications of the Malhotra disclosure may be prone to ambiguity about the status of the task associated with the file and do not keep track of tasks that may be waiting on a file. Other proposals, such as U.S. Pat. No. 9,026,590 to Michel, provide shared calendaring services useful in case management, however, these proposals fail to solve the deficiencies of the file-sharing systems. Relying on two distinct systems, such as those taught by Malhotra and Michel, provides ample opportunity for a break in communication about the status of documents and their respective due dates. Additionally, the calendaring system in Michel is further deficient because it does not allow for status updates, thus making it easy for a task to be forgotten until it is too late.

In addition to the deficiencies present in Malhotra, many are reluctant to use these systems to share sensitive information. There is not only a fear of these sources being hacked when shared across multiple networks, but file-sharing services such as Google Drive™ scan uploaded documents to gather information about the user. Thus, the file-sharing systems have not been reliably secure and are limited in their applicability with sensitive information.

Thus, although various proposals have been made for case management, communication, and file sharing, none of those in existence combine the characteristics of the present invention. Therefore, there remains a need for a secure system for case management with integrated file sharing and secure communication across multiple networks.

### SUMMARY

The present disclosure is directed to a method and system for providing secure case management across at least one communication network. More particularly, embodiments of the method and system described are operative to receive a first user's identifying information and at least one secondary user's identifying information, generate a first user and at least one secondary user profile, create a directory wherein the first user and at least one secondary user are members, receive case information and create a case associated with the case information, and securely transmit, across a communication network, the case to the members in the directory.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system may comprise processors, implemented by a computing system, configured to receive identifying information associated with the first user and at least one secondary user. It will be understood that one or more processors may be housed by a computing device such as a smartphone, tablet, desktop, laptop or other computer operative to receive and transmit data defining, at least text-based and messages, and text, audio, and image files, among others, of various formats known to those of ordinary skill in the art. Of course, unlimited numbers of users and associated profiles are contemplated, however, this disclosure will focus on a first user and their associated secondary profiles for the sake of brevity and in the interest of clarity.

The system may be configured to generate the first user profile in response to receiving a first user's identifying information. In some embodiments, the first user's identifying information may, as a non-limiting example, comprise information such as the first user's name, location, date of birth, and contact information, such as email addresses and telephone numbers, and any other identifying information as needed or desired. Further, the first user's identifying information may further comprise information relating to at least one credential of the first user. The at least one credential may, for example, and without limitation, be the first user's profession, licenses, area of expertise, and/or professional affiliation(s). A person of ordinary skill will appreciate that the provided examples of identifying information are provided for example only and any information capable of identifying a user is available. As a clarifying example, and without limitation, when the first user is an attorney, the identifying information may be any or a combination of at least the name and location of a law firm or company employing the attorney; an email address, mailing address and phone number at which to reach the attorney; a state in which the attorney is admitted to practice; and a type of law that the attorney practices, such as personal injury.

The system may, in one embodiment, generate the at least one secondary user profile in any of the same manners as discussed with the first user profile. However, in another embodiment, the first user may create the at least one secondary user account.

In some embodiments, at least one secondary user may be a professional associated with the case. For example, the at least one secondary user may be a private investigator, medical professional, another attorney, and/or expert witness. A person of ordinary skill will appreciate that the professions are provided for example only and should be understood as non-limiting. However, it is contemplated that the at least one secondary user may be a user who has knowledge about the case. Indeed, in some embodiments, the at least one secondary user may be a professional who has knowledge of the case. The knowledge may be pre-existing knowledge prior to accessing the case, however, the knowledge may be acquired after accessing the case.

As a clarifying example, the at least one secondary user may be a medical professional. The medical professional may be, for example, a physician who has information regarding the case. For example, in a case related to personal injury or guardianship, among others, a physician may be required or desired to provide a professional, relevant, assessment of a party to the case. Such physician may be, for instance, the client's primary care physician, or a specialist, such as a psychologist, surgeon, neurologist, or physical therapist, among many others. In some instances, the knowledge may be acquired during initial treatment and/or diagnosis, and thus may be pre-existing knowledge. Indeed, it is contemplated that in some cases, a medical professional may provide information regarding the party represented in the case prior to any incidents giving rise to the case. However, the knowledge may be acquired following the at least one secondary user accessing the case. Such knowledge may be acquired by, as a non-limiting example, another physician (as a tertiary user of the system) offering a second opinion on the patient-party's condition, or another specialist physician (as a further user of the system) providing further or alternative insight on the patient's condition.

As another non-limiting example, a secondary user may be an insurance adjuster providing an assessment of some monetary value associated with the case.

Still, a person of ordinary skill will appreciate that the foregoing are examples only, and the exemplary at least one secondary users above are provided for example only and not limitation, and any individual may be a secondary user.

The system may receive the case information and may create the case. In some embodiments, the case information may comprise information relating to a client, or, in other words. a party to an in process or potential legal proceeding. The case information may, for example, comprise the client's biographical information, such as name, age, birthdate. and address, the client's contact information, such as the client's email and telephone number, and any other information used to identify the client, as needed or desired. In one particular embodiment, the case information may comprise information relating to a legal matter, such as a lawsuit. Thus, the case information may comprise information relating to a plaintiff, defendant, court, opposing party or counsel, case number, filing date, jurisdiction, and status of the lawsuit. A person of ordinary skill in the art will appreciate the provided as non-limiting examples and that any information may be utilized. Moreover, a person of ordinary skill in the art will understand that the system may be utilized in the absence of the client, or for an abstract client such as the State in the prosecution of many matters, and may be used for any purpose.

It is contemplated that the case information may be received from the first user. However, in another embodiment, the case information may be received from a third-party source and the case may be assigned to the first user. For example, the third-party may be a referral service, secretary, physician, or the client themselves, however, a person of ordinary skill will appreciate that these are provided for example only and without limitation.

In some embodiments, the case may comprise at least one aspect related to a specific topic of the case. It is contemplated that the at least one aspect of the case may increase the organization of the case by allowing each of the at least one aspect of the case to be taken separately while remaining under the case in general. For example, the case may be a legal matter and the at least one aspect of the case may be a topic of discovery, witness information, papers to be filed with a court, and billing. Thus, by separating the at least one aspect of the case, the member may easily navigate and access a desired topic within the case. Indeed, it is contemplated that by separating topics in this manner, it will be possible to more readily restrict or grant user access to certain aspects, and other materials associated with the case, on privileged, need-to-know, or any other basis, such as mere relevance to each user.

In some embodiments, the at least one aspect of the case may comprise a means to further limit access to limited users or members. For example, the at least one aspect may require a code, password, digital key, or the like, to access information relating to the aspect. In one embodiment, the at least one aspect may be separately encrypted from the case. By separately encrypting the at least one aspect, it is contemplated that the at least one aspect may be accessible to less than all the members in the directory. This may limit the sharing of secure information to only the members in the directory who need access. Further, this may reduce confusion by removing aspects of the case which are not relevant to the member while allowing a centralized communication hub where some of the members may access all of the at least one aspect of the case.

A person of ordinary skill will appreciate that the provided examples of aspects of the case and manner of restricting users are provided as non-limiting examples only.

In one embodiment, at least one contribution may be received from the at least one secondary user. However, it is contemplated that in some embodiments, the at least one contribution may be received from the first user. Indeed, it is contemplated that the at least one contribution may be received from any member in the directory. It is contemplated that the at least one contribution may be information relating to the case. The information may, as a non-limiting example, comprise files, notes, photos or other images, memos, messages, opinions, or any other information relating to the case. The at least one contribution may be stored in the case and may be accessible by the members in the directory. In one embodiment, the at least one contribution may be stored within a folder attributed with at least one aspect of the case and may be accessible to less than all the users in the directory.

In a further embodiment, the at least one contribution may comprise at least one deadline associated with the case. More particularly, the at least one deadline may be associated with the at least one aspect of the case. In some embodiments, the at least one deadline may be displayed on a calendar. As just illustrative example of innumerable possibilities, it is well known that discovery-the formal process of exchanging evidence and information between opposing parties to a legal dispute-is given a final deadline before trial to prevent the parties from hiding information. Thus, an aspect of the case directed to discovery may comprise a contribution comprising at least one discovery deadline.

In some embodiments, the at least one contribution may be requested by any of the members in the directory. It is contemplated that in response to receiving a request for at least one contribution, the system may be operative to generate and display a prompt on at least one computing device of any of the members in the directory. More particularly, the at least one contribution may be requested from a specific member of the directory, and the prompt may be displayed on a computing device associated with the specific member. However, the at least one contribution may be received even in the absence of the request. For instance, the system may be operative to receive notes and/or memos from an attorney member as a contribution to any desired aspect of the case at any time, in the absence of a request.

It is contemplated that the directory may act as a gatekeeper that determines who may access the case, and even certain aspects of the case. Thus, any user that is not a member in the directory may not access the case.

In some embodiments, the directory may be updated during use. It is contemplated that at least one secondary user profile may be added to the case after the directory is created, and, thus, the directory may be updated to include the added at least one secondary user profile. It is also contemplated that any of the members in the directory may be removed and thus may no longer be a member of the directory with access to any of its contents. In some embodiments, only an administrative member may remove another member from the directory. In some embodiments, the member associated with the first user profile may be the administrative member. In some embodiments, the administrative member may be assigned or reassigned to another user profile. However, in some embodiments any member of the directory may remove another member of the directory. Further, in some embodiments, the system may, on its own volition, remove any of the members of the directory. It is contemplated that this may occur if a user's credentials have lapsed, due to inactivity the passage of time, or upon some member expiration date, among others.

It is contemplated that in some embodiments, the first user account and/or the at least one secondary user account may be associated with a plurality of cases. In some instances, the first user account and the at least one secondary user account may be associated with the same plurality of cases. However, the first user account may be associated with the plurality of cases, and the at least one secondary user may be limited to the plurality of cases in which they are members in the directory associated with the case. Indeed, the at least one secondary user may be limited to access only the case in which they are members in the associated directory.

In accordance with one embodiment, the system may selectively assign the at least one secondary user profile as member in the directory according to the at least one secondary user's identifying information received. In some embodiments, the members in the directory may be limited by at least one requested credential. Thus, the at least one secondary user in the directory may be identified by any of the at least one requested credential. The at least one requested credential may, for example, be confirmation or receipt of the user's profession, license, or area of expertise as needed or desired. Further, the various identifying information may comprise information relating to the secondary user's relation to the case. In one exemplary, non-limiting example, the case may be a personal injury case, and the secondary user may be a medical professional who has treated the client.

In another embodiment, the at least one requested credential may be a referral from the first user. The referral may, as a non-limiting example, be an electronic invitation, such as a QR-code or link, an alphanumeric code, or any other referral that may be known in that art.

It is contemplated that only those members in the directory may access the case information and the at least one contribution associated with the case. In some embodiments, the directory may further define a level of access for each of the members, noted briefly above. In one embodiment, each of the members may access all case information and the at least one contribution associated with the case. In another embodiment, however, any of the members may access less than all case information and the at least one contribution associated with the case. Indeed, in one such embodiment, the access may be limited to the folder associated with one of the at least one aspects of the case. It is contemplated that the members may only access the folder associated with the at least one aspect of the case that the each of the members is assigned to.

In some embodiments, the directory may further comprise at least one viewer user. The at least one viewer user may be a user who may access the case but is limited to viewing. Thus, in some embodiments, the system may not receive at least one contribution from the at least one viewer user. However, in other embodiments, the system may receive a limited at least one contribution from the at least one viewer user. For example, the limited at least one contribution may be “likes,” comments, and other reactions known to those of ordinary skill in the art.

It is contemplated that the at least one viewer user may, as non-limiting examples, be the client, insurance agent/adjuster, supervisor, or any other party/individual who may require access to the case.

In some embodiments, the at least one viewer user may be given access for a limited time, such as an hour, day, week, and month. In another embodiment, the at least one viewer user may be given access for an unlimited time. Further, in one embodiment, the at least one viewer user may access less than all of the cases. For example, the at least one viewer user may access a limited number of the folders associated with the at least one aspect of the case. However, in another embodiment, the at least one viewer user may access the case in its entirety.

The system may securely transmit the case to the members in the directory using any secure method of transferring files across the communication network. In one exemplary embodiment, securely transmitting the case may occur by encrypting the case. The encrypted case may be transmitted across the communication network to the members in the directory, where each of the members may access the case. Upon any of the members accessing the case, the system may, on a computing device associated with the member, decrypt the case. Thus, allowing the case to be securely transmitted across the communication network and allowing access to multiple users.

Several advantages of one or more aspects of the system and method for providing a secure case management and communication across at least one computing network are that they:
a.) enable approved members to securely share, across multiple networks, sensitive files;
b.) improve collaboration between multiple users;
c.) create a central communication hub, wherein the case and all contents may be accessed by the members in the directory; and
d.) allow selective access to the aspect of the cases to protect the sensitive nature of the contents.

Thus, it is an object of this system and method to provide a system for case management accessible on multiple computing devices.

It is a further object of this system and method to provide a case management program that enables members to securely share information with multiple approved users across a communication network.

It is an object of the invention to control access of the users to certain content of the case to preserve the sensitive nature of the documents.

It is yet another object of the invention to the system and method to connect professionals across a variety of industries.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1A is a blocked diagram of a networked environment in which an exemplary embodiment of a system for secure case management is implemented.

FIG. 1B shows an exemplary embodiment of a computing device in FIG. 1A.

FIG. 2 is a flowchart depicting an exemplary embodiment of a method for secure case management.

FIG. 3 shows an exemplary embodiment of the user interface for the system and method for secure case management associated in particular with a user profile creation module.

FIG. 4 shows an exemplary embodiment of the user interface for the system and method for secure case management associated in particular with a case creation module.

FIG. 5 shows an exemplary embodiment of the user interface for the system and method for secure case management associated in particular with a portfolio management module.

FIG. 6 illustrates an exemplary embodiment of the user interface for the system and method for secure case management associated in particular with a case management module.

FIG. 7 is a flowchart depicting an exemplary embodiment of a method for creating a directory associated with the case.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

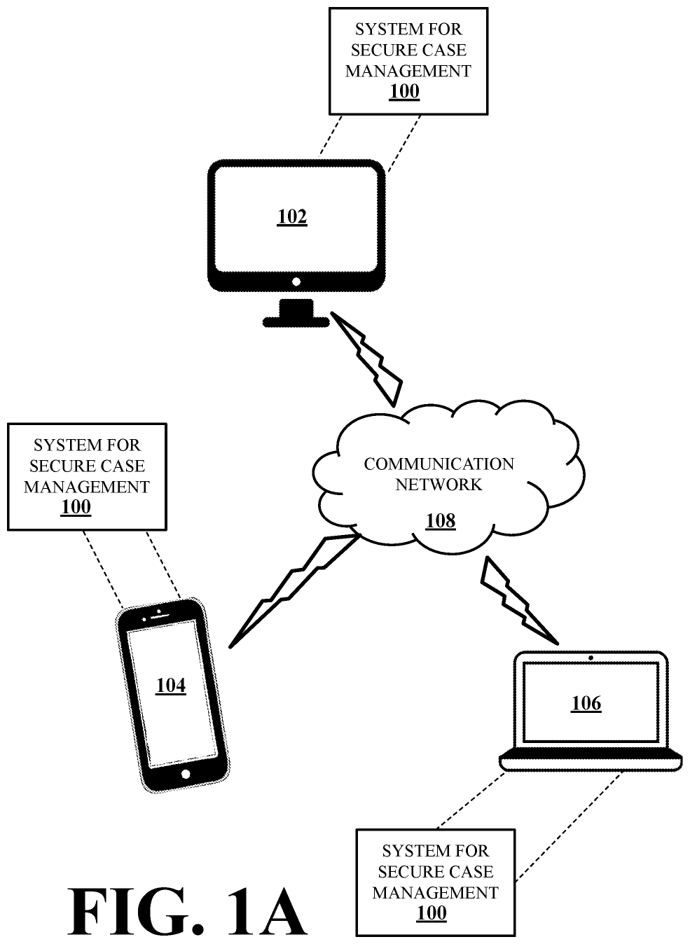

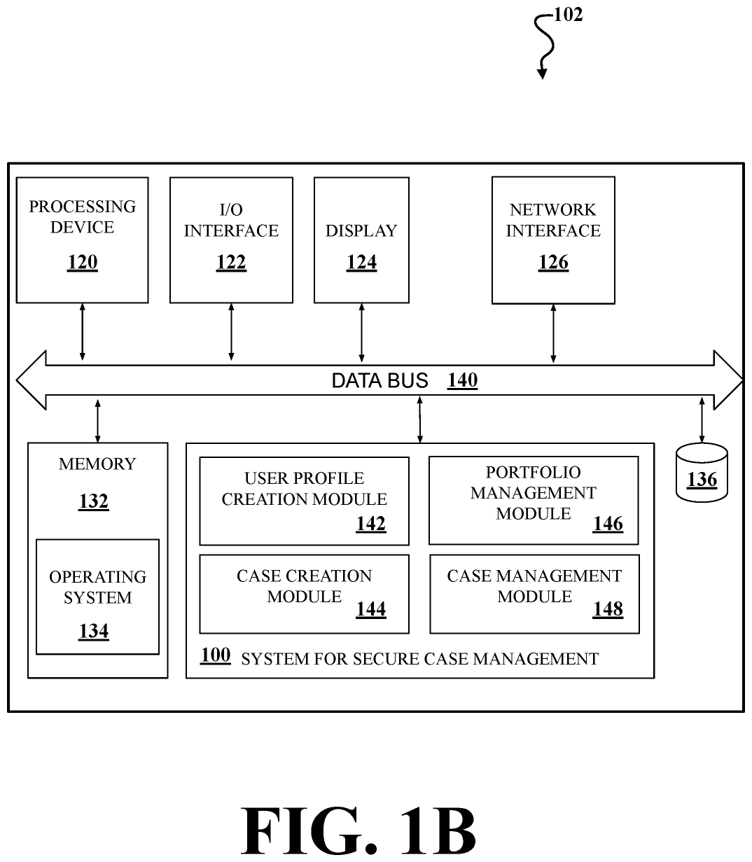

A description of an embodiment of a system and method for secure case management across at least one computing device is now described followed by a discussion of the operation of various components within the system. In this regard, FIG. 1A illustrates, in a block diagram, an exemplary embodiment of the system 100 for secure case management which includes at least one computing device 102, 104, and 106 coupled together via a communication network 108. By way of example, and not limitation, FIG. 1 illustrates three computing devices 102, 104, and 106. Each of the computing devices may be embodied as a personal computer, tablet computer, laptop computer, smartphone, or any other computing device known in the art. Notably the communication network 108 can use one or more various communication types such as, for example, and without limitation, cellular and Wi-Fi communications.

Users of computing devices 102, 104, and 106 may be members of a directory. The directory enables users to use their computing devices 102, 104, and 106 to interact with the system 100 for secure case management. Notably, the directory may enable users to use their computing devices 102, 104, and 106 to interact with each other.

A user of the at least one computing device 102, 104, and 106 may use their devices to access the system 100 for secure case management. In one embodiment, a first user may access the system 100 on a first computing device 102 and at least one secondary user may access the system 100 on a second computing device 104 or third computing device 106. More particularly, each of the at least one secondary user may access the system 102 on any of the second computing device 104 or third computing device 106.

It is contemplated that the first user may be an administrator and/or owner of the system 100 for case management.

In one embodiment, a third-party user may access the system 100 on the third computing device 106. In another embodiment, a viewer user may access the system 100 on the third computing device 106. However, a person of ordinary skill will recognize that any user may utilize any of the computing devices, and further that the system is not limited to three users or computing devices.

In this regard, the system 100 for secure case management includes various modules, which can be implemented in numerous ways such as, for example, and without limitation, a downloadable application, web-based application, website, or the like. For example, the system 100 receives member information to uniquely identify members of the directory (in this case, users of computing devices 102, 104, and 106). Additionally, system 100 receives information corresponding to any identifying information supplied by each user, case information, contributions, requests, and other information.

FIG. 1B illustrates an exemplary embodiment of any of the computing devices 102, 104, and 106 shown in FIG. 1A. For the purposes of clarity, FIG. 1B will be discussed with reference to computing device 102, however, any computing device may be utilized. As described, computing device 102 may be a tablet computer, personal computer, laptop computer, or smartphone, but may also be embodied in any one of a wide variety of wired and/or wireless computing devices. As shown in FIG. 1B, computing device 102 includes a processing device (processor) 120, input/output interfaces 122, a display 124, a network interface 126, a memory 132, an operating system 134, and a mass storage 136 with each communicating across a local data bus 140. In some embodiments, the computing device 102 may further include a touchscreen interface and even a GPS (not pictured). Additionally, computing device 102 incorporates a system 100 for secure case management which is depicted as including a user profile creation module 142, a case creation module 144, a portfolio management module 146, and a case management module 148, although the location of information 142, 144, 146, and 148 could vary. Each module comprises certain information and data, or is configured to receive and execute instructions related to certain information and data, or is configured to receive and execute instructions related to certain information and data which will become clearer with reference to the particular methods and exemplary user interfaces discussed, in turn, below.

The processing device 120 may include any custom made or commercially available processor, a central processing unit (CPU) or an auxiliary processor among several processors associated with the computing device 102, a semiconductor based microprocessor (in the form of a microchip), a macro processor, one or more application specific integrated circuits (ASICs), a plurality of suitably configured digital logic gates, and other electrical configurations comprising discrete elements both individually and in various combinations to coordinate the overall operation of the system.

The memory 132 can include any one of a combination of volatile memory elements (e.g., random-access memory (RAM, such as DRAM, and SRAM, etc.)) and nonvolatile memory elements. The memory typically comprises native operating system 134, one or more native applications, emulation systems, or emulated applications for any of a variety of operating systems and/or emulated hardware platforms, emulated operating systems, etc. For example, the applications may include application specific software which may comprise some or all the components of the computing device 102. In accordance with such embodiments, the components are stored in memory and executed by the processing device. Note that although depicted separately in FIG. 1B, the system 100 for secure case management may be resident in memory, such as memory 132.

One of ordinary skill in the art will appreciate that the memory 132 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 1B, network interface device 126 comprises various components used to transmit and/or receive data over a networked environment such as depicted in FIG. 1A. When such components are embodied as an application, the one or more components may be stored on a non-transitory computer-readable medium and executed by the processing device.

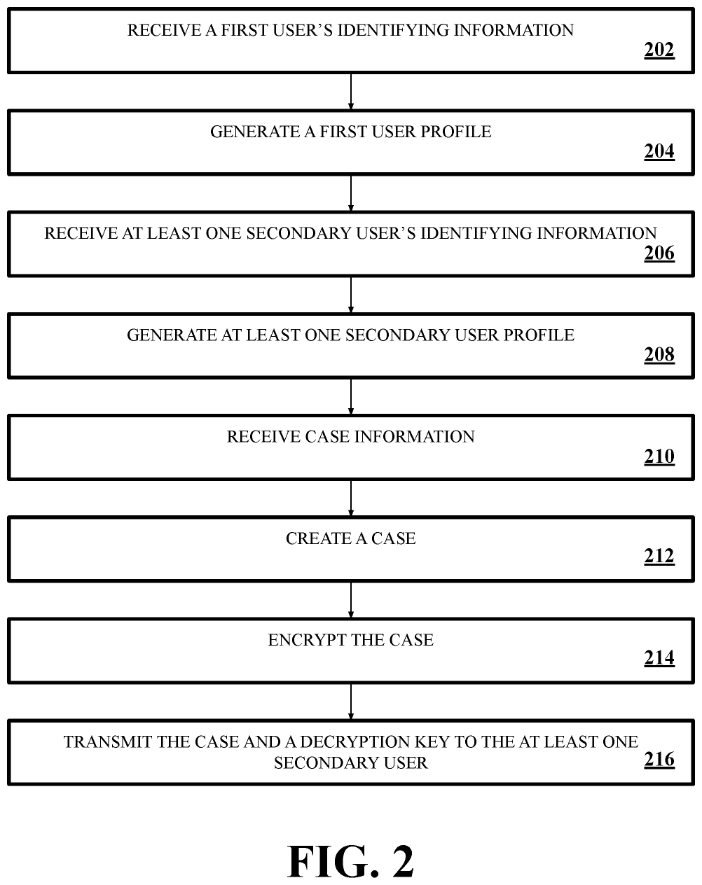

With reference to FIG. 2, an exemplary method 200 for case management carried out by a system is provided. The method includes the steps of: receiving a first user's identifying information 202; generating the first user profile 204; receiving at least one secondary user's identifying information 206; generating at least one secondary user profile 208; receiving case information 210; creating a case 212 from the received case information; encrypt the case 214; and transmitting the case and a decryption key to the at least one secondary user 216.

The first user's identifying information may comprise all or part of the first user's name, contact information, location, date of birth, and any other contact information known in the art. The contact information may, for example, and without limitation, comprise the first user's email address, telephone number, mailing address, or any other contact information known in the art. In some embodiments, the first user's identifying information may further comprise at least one credential such as, without limitation, the first user's profession, licenses, area of expertise, specialty, and/or professional affiliation(s). In one example, the at least one credential of the first user may have a license to practice law in a particular state and have a specialization in personal injury law. However, a person of ordinary skill will recognize that the aforementioned identifying information is provided for example only and that any identifying information may be utilized.

The step of generating the first user profile 204 may utilize the first user's identifying information received in the aforementioned step 202 to create the first user account. In one embodiment, the first user's identifying information may be assigned to a first user identifier. For example, the user identifier may be the first user's own name or email address, or any other username known to those of ordinary skill in the art, such as any unique series of numbers, letters, or combination of numbers and letters as selected by or assigned to the first user. In some embodiments, the first user identifier may comprise any digital key known to those of ordinary skill in the art. It is contemplated that the first user identifier may be utilized to identify the first user on a variety of computing devices such as, for example, and without limitation, the computing devices shown in FIG. 1.

Returning to FIG. 2, the system 200 may receive at least one secondary user's identifying information 206. The at least one secondary user's identifying information may, without limitation, comprise the same identifying information as the first user's identifying information. For example, the at least one secondary user's identifying information may comprise contact information, name, location, date of birth, and any other identifying information known in the art. Additionally, the at least one secondary user's identifying information may comprise at least one credential such as profession, area of expertise, location, licenses, or any other credentials that may be contemplated. It is contemplated that in some exemplary embodiments, the at least one secondary user may be a professional. For example, the at least one secondary user may be a medical professional, a private investigator, an insurance agent/adjuster, an attorney, an expert, mediator, and/or any other professional known in the art. In particular, the at least one secondary user may be any professional who may have information relating to the case.

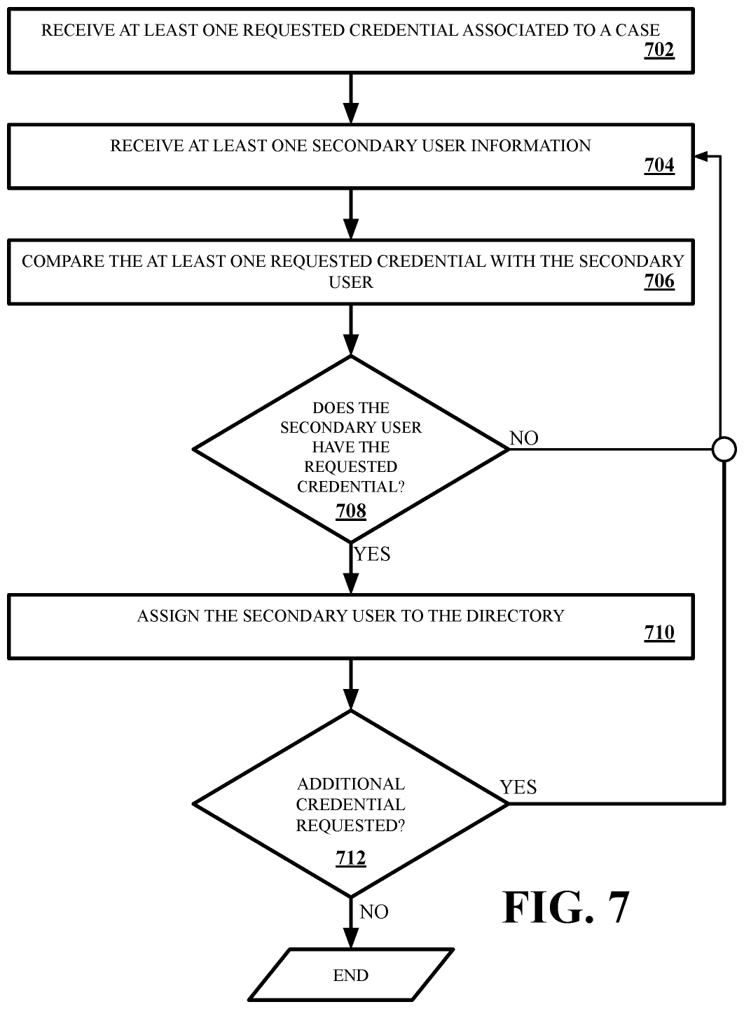

In some embodiments, the at least one secondary user may comprise at least one requested credential. The at least one requested credential may be any credential that is desired for the members in the directory to possess. One exemplary example of the at least one requested credential is discussed in more detail with regard to FIG. 7.

Continuing with FIG. 2, at least one secondary user profile may be generated 208. The at least one secondary user profile may comprise the at least one secondary user's identifying information received in the aforementioned step 206. It is contemplated that the at least one secondary user profile may be generated in the same manner as the step for generating the first user profile 204. Thus, the at least one secondary user's identifying information may be assigned to at least one secondary user identifier and may, as non-limiting examples, be the at least one secondary user's name, email address, or any other username known in the art. It is contemplated that the first user identifier and the at least one secondary user identifier may be unique. However, in some embodiments, the first user identifier and the at least one secondary user identifier may comprise similar elements. For instance, in some embodiments, user identifiers may be at least partially defined by each user's credentials, in addition to any modifiers unique to such users. It is contemplated that this could make the role of each user in the case readily identifiable to each other. In some embodiments, user identifies may simply be each user's own name.

Case information received in step 210 may, in some embodiments, be received from the first user. However, in other embodiments, the case information may be received from any user such as the at least one secondary user, third party user, or viewer user. In yet another embodiment, the case information may be received from multiple users.

The case information may comprise information relating to any of a client, dispute, and/or project at issue. Further, the case information may comprise any information that a person of ordinary skill in the art may contemplate. For example, the case information may comprise a client's biographical information, contact information, or any other information that may identify the client. Further, case information relating a project may depend on the purpose behind the case. For example, when the case relates to a legal case, such as a lawsuit, the case information may comprise the identities of the plaintiff(s), defendant(s), opposing counsel or party, a court where the case is filed, a status of the case, case number, filing date, jurisdiction, and any other information relating the legal case. However, a person of ordinary skill will appreciate that the aforementioned examples are provided without limitation and that the system and method may be utilized with any project and in many fields, such as construction, medicine, photography, any/or any field reliant on independent contractors.

The case may be created 212 from the case information received in the previous step (210). Such, the case may comprise the information relating to the case information received. In some embodiments, the case information may be assigned to a case identifier that identifies the case. The case identifier may, for example, be the client's name, case name, or any other username known to those of ordinary skill in the art, such as any unique series of numbers, letters, or combinations of numbers and letters.

Following the creation of the case 212, the case may be encrypted 214. It is contemplated that the encryption may be any encryption known in the art such as, and without limitation, symmetric and asymmetric encryption. For example, the system may utilize asymmetric encryption such as, as a non-limiting example, end-to-end encryption. In another example, the system may utilize symmetric encryption such as block encryption algorithms or stream algorithms. Indeed, the encryption may be any encryption known in the art.

It is contemplated that the encryption utilized may be used to protect the contents of the case when transmitted to the at least one secondary user 216 and the decryption key may be any decryption key operative to decrypt the encrypted case. A person of ordinary skill will appreciate that this may depend on the encryption utilized in the previous step 214.

As shown in FIG. 2, the case may be transmitted to at least one secondary user 216. However, it is contemplated that the case may be transmitted to any user, including, without limitation, the first user, the third-party user, and/or the viewer user.

With reference to FIGS. 1A and 2, the step of receiving the first user's identifying information 202 may be received on the first computing device 102. The step of receiving the at least one secondary user's identifying information 204 may be received on the second computing device 104. The case information may be received 210 from the computing device belonging to the user who provides the case information. In some exemplary embodiments, the case information may be received 210 from the first user and thus received on the first computing device 102. However, in another embodiment, the case information may be received 210 from the second computing device 104 or third computing device 106 from the at least one secondary user. Indeed, a person of ordinary skill will appreciate that the any of the steps described in FIG. 2 may be carried out on any of the computing devices 102, 104, and 106 from FIG. 1A.

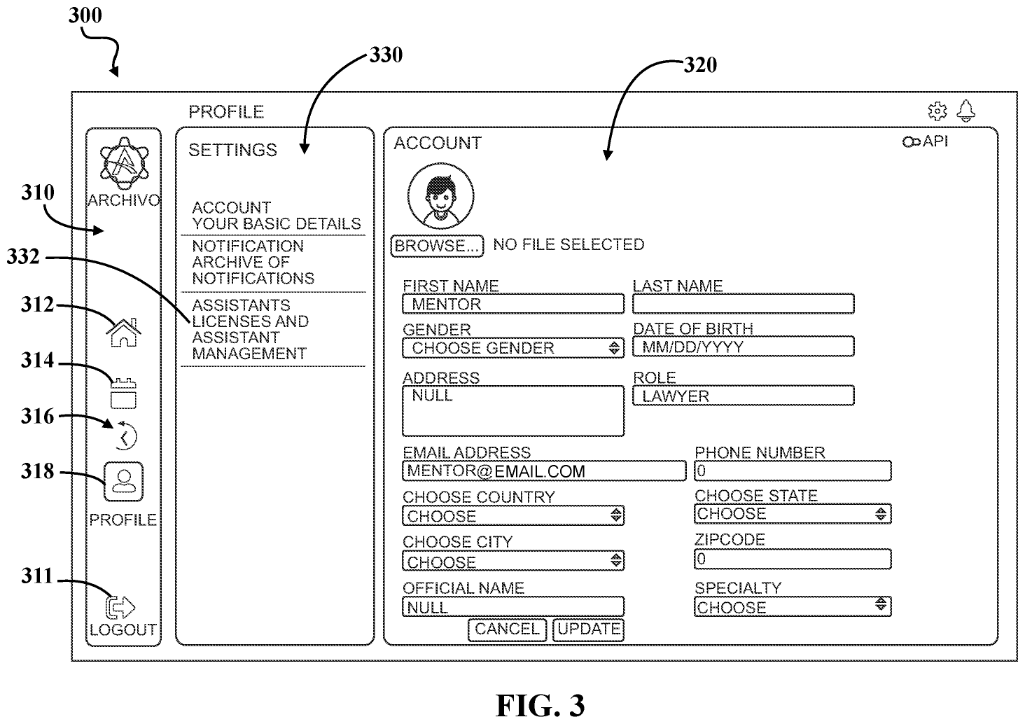

FIG. 3 illustrates an exemplary, non-limiting embodiment of a user interface 300 for the user profile creation module. Namely, the system may comprise a computer system implemented by processors configured to receive identifying information from the user. It is contemplated that the user may be any of the first user, at least one secondary user, third-party user, or viewer user.

The system may, at a graphical user interface, prompt the user to provide their own identifying information 320 including, for example, the user's FIRST NAME (here, MENTOR), LAST NAME, GENDER, DATE OF BIRTH, ADDRESS, ROLE (here, LAWYER), EMAIL ADDRESS (here, MENTOR@EMAIL.COM), PHONE NUMBER, COUNTRY, STATE, CITY, ZIPCODE, OFFICIAL NAME, and SPECIALITY to identify themselves to other users in the system. Of course, one skilled in the art will recognize other forms of identifying information 320 that may be prompted.

The system may be further configured to receive an identifying image of the user. The identifying image of the user may be received in response to a clickable element that prompts the user to upload their identifying image. As shown in FIG. 3, the clickable element may be a button that prompts the user to “BROWSE . . . ” files stored on the user's computing device. In response to the selection of the file, the file may be uploaded, and saved in the user's profile. However, in another embodiment, the system may comprise a series of pre-uploaded identifying images that may be assigned to the user profile.

The interface may further display clickable prompts 330 that when clicked are operative to display a new interface. For example, the prompt “ASSISTANTS LICENSES AND ASSISTANT MANAGEMENT” 332 may display at least one assistant to the user. In such an example, the assistant's licenses may be attributed to the at least one credential of the user.

FIG. 3 further illustrates an exemplary navigation bar 310 operative to navigate throughout the system. The navigation bar 310 may be displayed in each of the system's interfaces. In the exemplary embodiment of the navigation bar 310 shown, the navigation bar 310 may comprise at least one shortcut, such as HOME 312, calendar 314, tasks 316, PROFILE 318, and LOGOUT 311. However, a person of ordinary skill will appreciate that the aforementioned shortcuts and attributed names are provided for example only and are not limiting.

The user interface 300 for creating any of the user accounts displayed in FIG. 3 may be displayed when the PROFILE 318 shortcut is selected. If the calendar 314 shortcut is selected, the system may display any calendar interface known in the art. For example, the calendar may be a monthly calendar, yearly calendar, weekly calendar, or even a daily calendar. If the tasks 316 shortcut is selected, the system may display at least one task of the member. The at least one task may, in some embodiments, be ordered in a task list specific to the member. It is contemplated that the at least one task may be any task associated with the case. For example, the task may be to upload a file, such as a medical file or report, attend a mediation settlement, file papers, meet with another member or the client, or any other task that a person of ordinary skill will contemplate. In some embodiments, the at least one task may comprise a due date for the task. In some embodiments, the at least one task may be displayed in the calendar interface.

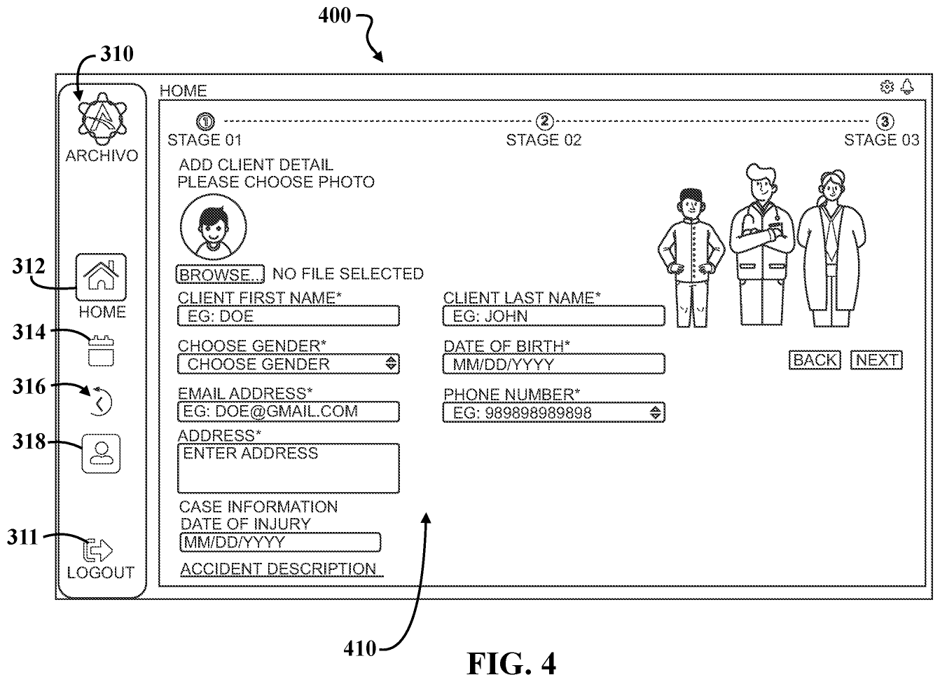

If the HOME 312 shortcut is selected, the system may display any the interfaces shown in any of FIGS. 4-6.

FIG. 4 illustrates an exemplary, non-limiting embodiment of a user interface 400 for the case creation module. Namely, the system may be configured to display, on the graphical user interface, a series of prompts instructing the user to input a client's information 410. As shown in FIG. 4, the client's information may comprise the CLIENT FIRST NAME, CLIENT LAST NAME, GENDER, DATE OF BIRTH, EMAIL ADDRESS, PHONE NUMBER, ADDRESS, and CASE INFORMATION. The CASE INFORMATION may comprise the DATE OF INJURY and an ACCIDENT DESCRIPTION, as shown in FIG. 4. Further, the CASE INFORMATION may comprise a dollar amount of policy limit coverage, a dollar amount of the policy used, client occupation and salary, a police report number, paying party information, accident information, and any other case information known in the art. Any user responses to the prompts may be carried out by the user and received through various clickable elements and/or text boxes on the graphical user interface.

It is contemplated that the client information and case information collected may define the case. However, the graphical user interface may further prompt the user to input additional information. The additional information may be dependent on the CASE INFORMATION inputted. For the purposes of brevity and in the interest of clarity, the additional information discussed is limited to a personal injury lawsuit. Of course, the system may be utilized for innumerable projects and thus should not be considered limited by the provided examples.

The additional information may, in one embodiment, comprise a medical professional's information, including a name of the medical professional, department, physical address, email address, and phone number. It is contemplated that the medical professional may, for example, and without limitation, be a primary care physician, emergency room physician, physical therapist, specialist, or any other medical professional known in the art.

In another embodiment, the additional information may comprise an attorney's information. The attorney's information may include, as non-limiting examples, a name of the attorney, specialty, physical address, email address, and phone number. It is contemplated that the attorney information may further comprise any other information as needed or desired.

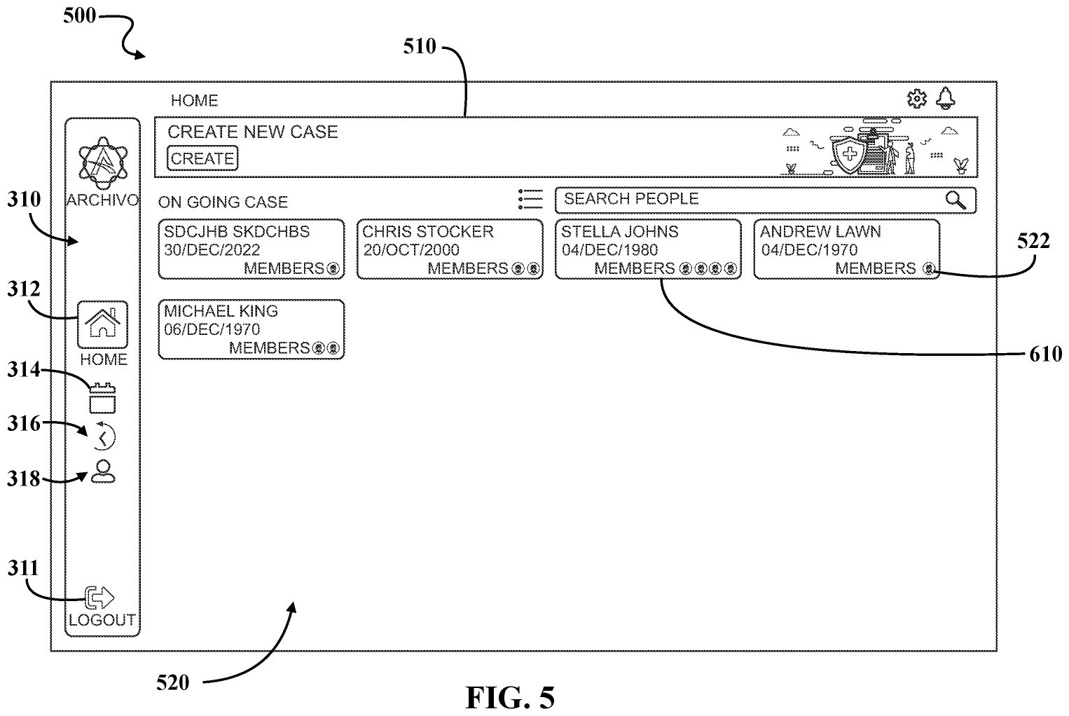

FIG. 5 illustrates an exemplary, graphical user interface 500 of one instance of the portfolio management module. The portfolio management module comprises a portfolio 520 that comprises at least one case in which the user is a member of the directory. The at least one case may, for example, be any number of ongoing cases 520. As shown in FIG. 5, the ongoing cases 520 may be any number, such as five (5) cases. However, it is contemplated that there may be no ongoing cases (not shown) thus, no cases may be displayed in the ongoing cases 520 section of the display in some embodiments.

In the exemplary embodiment shown in FIG. 5, the interface 500 may display some of the case information in the portfolio. It is contemplated that this information may be operative to quickly identify to the user identifying facts of the case. In the example illustrated, the identifying facts comprise the client's name and date of birth. However, it is contemplated that the displayed information may be any identifying fact, including, without limitation, a brief synopsis, case number, type of case, or any other information. Further, in some embodiments, not shown, a nickname may be assigned to the case.

Returning to the exemplary embodiment in FIG. 5, the identifying facts of the case displayed may include the members in the directory. As shown, the members may be displayed as images 522 that are specific to each member in the directory. Further, in some embodiments where the member does not have an image, another identifier may be used, such as, and without limitation, the member's initials.

The system may, at the graphical user interface, prompt the user to “CREATE NEW CASE” 510. As shown, the prompt to CREATE NEW CASE 510 may be received on a clickable button, however, one skilled in the art will recognize that user responses to prompts may be received through various clickable elements on the graphical user interface. Upon receiving a response to the CREATE NEW CASE 510 prompt, the system may display the user interface shown in FIG. 4. However, it should be appreciated that any user interface operative to receive case information may be displayed and utilized.

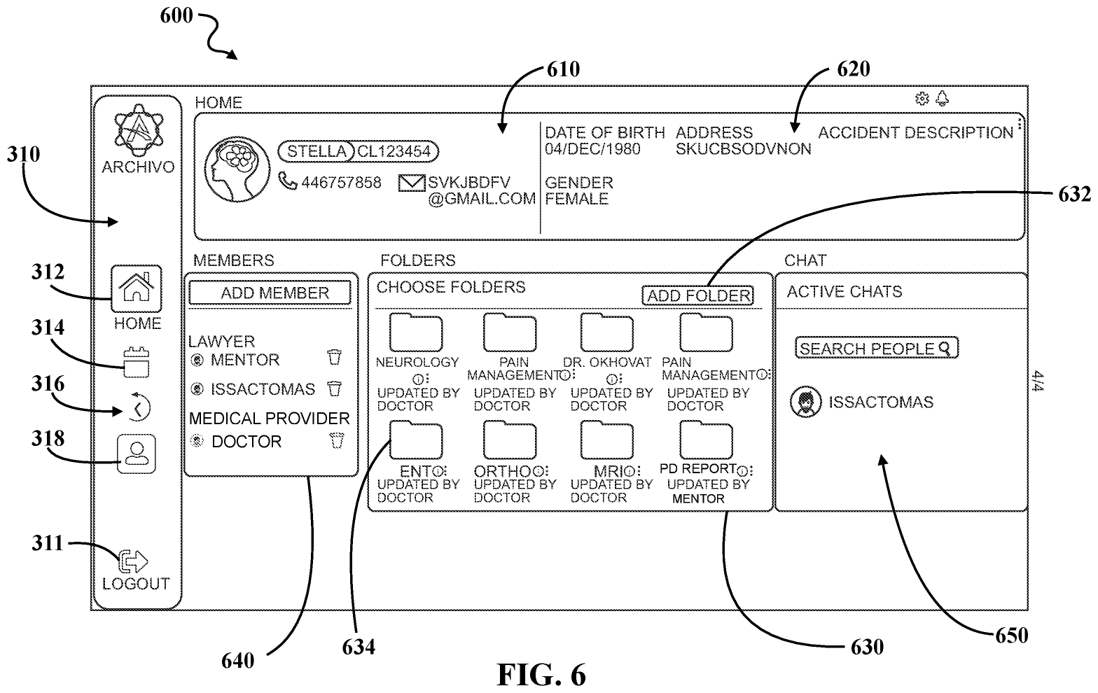

FIG. 6 illustrates one exemplary embodiment of an interface 600 for the case management module. It is contemplated that the case management module may be a centralized communication hub specific to the case. The centralized communication hub may allow at least one member 642 of the directory 640 to access the case information and at least one contribution. The interface 600 may, for example, display the client's information 610 and case information 620 received in the graphical user interface illustrated in FIG. 4. The interface 600 may further display the portfolio 630 comprising at least one folder 634 associated with each of at least one aspect of the case. It is contemplated that each of the at least one aspect of the case may relate to a specific topic within the case, for example, different specialists, witnesses, moving papers, finances, or other topics. The at least one aspect of the case, as illustrated in FIG. 6 include topics such as NEUROLOGY, PAIN MANAGEMENT, DR. OKHOVAT, PAIN MANAGEMENT, ENT, ORTHO, and PD (police department) REPORT.

In the exemplary embodiment shown in FIG. 6, each of the at least one aspect of the case may define a folder.

Additional folders may be created in response to a response to a displayed prompt to “ADD FOLDER” 632. In some embodiments, the “ADD FOLDER” 632 prompt may only be displayed to a primary member of the directory 640, typically associated with the first user account. However, in another embodiment, the prompt to “ADD FOLDER” 632 may be displayed to any member in the directory 640.

In some embodiments, following the response to the “ADD FOLDER” 632 prompt, the system may create a new folder in the portfolio 630. The system may prompt the member to provide identifying information for the new folder. For example, the identifying information may comprise a folder name, contributing members, keywords, description, permissions, or any other information that may be contemplated. However, in another embodiment, following the response to the “ADD FOLDER” 632 prompt, the system may prompt the member to upload a previously created folder stored, for example, on the member's computing device. It is contemplated that the system may be operative to receive the folder in any uploading method known in the art, including, without limitation, a clickable button or “drag and drop” file uploading.

Following the creation of the new folder in the portfolio 630, the system may prompt the user to upload at least one contribution to the system. The at least one contribution may, in some embodiments, be a file received by the system. The prompt to upload the file may appear on a clickable button, however, one skilled in the art will recognize that user responses to prompts may be received through various clickable elements on the graphical user interface. In, the system may allow the member to add the new folder through “drag and drop” file uploading. Of course, any method of file uploading known in the art may be utilized. Additionally, it is contemplated that the at least one contribution may be directly inputted into the system. For example, the at least one contribution may be the selection of at least one clickable element, text, checkbox, or any other input known in the art.

It is contemplated that a member in the directory 640 may have access to less than all the folders 630. Thus, only the folders 634 that the member has access to may be displayed. This is contemplated to preserve the secure nature of the folder's contents when shared with the directory, while still creating a centralized case accessible to the first user. Of course, it is contemplated that the member may have access to all of the folders 634 in the case.

FIG. 6 further displays one exemplary embodiment of the directory 640 comprising at least one member 642. The at least one member 642 may be any of the at least one secondary user assigned to the directory 640 in FIG. 7.

FIG. 7 illustrates one method of assigning at least one secondary user to the directory 700. Creating the directory may comprise the steps of receiving at least one requested credential for the matter 702; receiving at least one secondary user's identifying information 704; comparing the at least one requested credential with the at least one secondary user's identifying information 706; and assigning the at least one secondary user to directory 710 when the at least one secondary user has any of the at least one requested credential 708. If the at least one secondary user does not have the requested credential 708, the system may receive an additional at least one secondary user information 704 and if the additional at least one secondary user information has any of the at least one requested credential, the additional at least one secondary user may be assigned to the directory 710. The previous steps may be repeated until the directory comprises each of the at least one requested credentials. The at least one secondary user assigned to the directory should be understood to be the members in the directory. Further, it is contemplated that the members in the director may be users assigned in any method, including methods not described here.

Returning to the method described in FIG. 7, the at least one requested credential may, for example, be a license, profession, location, level of education, experience, cost, or any other credential that may be recognized. It is contemplated that the at least one requested credential may be any credential that may benefit the matter.

In one embodiment, the at least one requested credential may be ordered in a list of requested credentials. In some such embodiments, the list of requested credentials may be received from any of the users. In particular, the list of requested credentials may be received from the first user, however, the list of requested credentials may be received from the at least one secondary user, the third-party user, or the viewer user. In another embodiment, the list of requested credentials may be generated from the case. It is contemplated that each type of case, such as legal, medical, construction, or any other matter, may comprise a specific list of requested credentials. For example, the list of requested credentials specific to legal matters may comprise an area of expertise, availability, proximity to the client and/or court, and cost.

In some embodiments, the at least one requested credential may be prior knowledge of the matter. For example, a doctor who has treated the client following an injury may be deemed to have prior knowledge of the matter. Further examples include, without limitation, a police officer, a witness, or a prior attorney. In another embodiment, lack of prior knowledge may be one of the at least one requested credentials.

Further, in another embodiment, the at least one requested credential may be a referral from any of the users. For example, the at least one requested credential may be the referral from the first user, however, it may also be the referral from any user already assigned to the directory. In one particular example, the referral may be from the third-party user, such as a referral service, and may be operative to assign the first user to the directory.

The referral may utilize any method of referral known in the art. For example, the referral may be experienced-based, reputation-based, or specialization-based referrals. Further, the referral may take any form known in the art. In one example, the referral may be a message, such as an email or letter, directed to a desired at least one secondary user. In another example, the referral may be a general referral posted in a central area, such as an office or web forum. It is contemplated that while the referral may be posted in any central area, it may be advantageous to post the referral in a central area frequented by those who may possess the at least one requested credential. In any aforementioned embodiment, the referral may comprise a means for accessing the system. The means for accessing the system may, for example, be a link to a webpage, QR-code, hyperlink, provided username and password, or any other means for accessing the system known in the art.

It is contemplated that not all users who possess at least one requested credential may be assigned to the directory. In some embodiments, the system may comprise an intermediary step between determining if the at least one secondary user has the requested credential 708 and assigning the at least one secondary user to the directory 710. The intermediary step may be receiving an input operative to approve the at least one secondary user as a member in the directory. In some embodiments, the approval may be received from the first user, however, in another embodiment, the approval may be received from the at least one secondary user. In yet a further embodiment, the approval may be determined by the system itself. Thus, the system may be operative to determine a compatibility of the user with the case. The compatibility may be determined by, for example, seeing how many of the requested credentials the user possesses, the number of ongoing cases the user is currently a member of, or any other information contemplated.

It is contemplated that the at least one requested credential may be a specific member in the directory. In some embodiments, each member in the directory may comprise a specific role related to the case. More particularly, the specific role for each member may be related to the at least one aspect of the case, discussed with regard to FIG. 6.

The at least one member 642 may be displayed under a title relating to their role in the case. The example shown in FIG. 6 comprises the title “MEDICAL PROFESSIONAL” and “LAWYER” for the illustrated case. Of course, any other role is contemplated including for example, client, witness, insurance agent, investigator, or any role that may be useful to the case.

It is contemplated that the system may display the at least one member 642 using information received as discussed under FIG. 4. However, the at least one member 642 may be added from the interface displayed in FIG. 6. More particularly, the system may prompt the user to “ADD MEMBER” 644 to the directory 640. As shown, the prompt to “ADD MEMBER” 644 may be displayed as a clickable button. However, a response to the prompt may be received through various clickable elements on the graphical user interface.

It is contemplated that the system may display an interface operative to receive information relating to the “ADD[ed] MEMBER” 644. The “ADD[ed] MEMBER” 644 may then be displayed in the directory 640. More specifically, the “ADD[ed] MEMBER” 644 may be displayed under the title appropriate to their role.

The interface may further comprise a means for chatting 650 with other members in the directory 640. It is contemplated that the means for chatting 650 may allow the members in the directory 640 to send, across the communication network 108 illustrated in FIG. 1A, a text or voice and even visual and audio graphics as a message to another of the at least one member 642 in the directory 640. As shown, the means for chatting 650 may be utilized to send the message to an active member 652. The active member 652 may, as a non-limiting example, be at least one member from the directory who is accessing, at that time, the system, however, a person of ordinary skill will appreciate that the active member 652 may be determined by any member known in the art.

Additionally, in some embodiments, the means for chatting 650 may allow the message, in any form, to be sent to any member in the directory 640, regardless of their activity status.

The means for chatting 650 may be any chatting means known in the art. For example, the means for chatting 650 may be a pop-up window, tab, or any other means known in the art.

It is contemplated that the means for chatting 650 may allow for multiple of the at least one member 642 in the directory 640 to engage in a “group chat.” Thus, allowing a select number of the at least one member 642 in the directory 640 to chat about a topic within the centralized communication hub. This may allow direct communication without the need for separate forms of communication traditionally required.

### Conclusions, Ramifications, and Scope

While certain embodiments of the invention have been illustrated and described, various modifications are contemplated and can be made without departing from the spirit and scope of the invention. For example, the system and method may be used to connect educators and parents. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for secure case management across at least one communication network with which that terminology is associated. In general, the terms used in the following claims should not be constructed to limit the system and method for secure case management across at least one communication network to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for secure case management across at least one communication network is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for secure case management across at least one communication network.

What is claimed is:

1. A computer implemented method for sharing sensitive files across a network, comprising:
creating a first user profile, comprising:
receiving, at a first computing device, a first user's identifying information;
responsive to receiving the first user's identifying information, generating the first user profile;
creating at least a secondary user profile, comprising:
receiving, at a second computing device, at least one secondary user's identifying information;
responsive to receiving at least one secondary user's identifying information, generating a secondary profile associated with each the at least one secondary user's identifying information;
receiving, at the first computing device, case information;
creating a case associated with the case information;
creating a directory, wherein the first and at least one secondary users are members in the directory;
encrypting the case;
transmitting the case, through at least one computing network, to the members in the directory;
responsive to any of the members in the directory accessing the case, decrypting, on the computing device associated with the member, the case;
receiving at least one contribution from any of the members in the directory;
encrypting the at least one contribution; and
associating the at least one contribution with the case.

2. The method of claim 1, further comprising receiving an information request from any member of the directory and transmitting the information request to another of the members in the directory.

3. The method of claim 1, wherein the members in the directory further comprises a viewer user.

4. The method of claim 1, wherein the step of encrypting the case utilizes end-to-end encryption.

5. The method of claim 1, wherein the case comprises at least one aspect related to a specific topic of the case.

6. The method of claim 5, wherein the at least one contribution is associated with any of the at least one aspects related to the specific topic of the case.

7. The method of claim 5, wherein any of the at least one aspect is encrypted separately from the case.

8. The method of claim 7, wherein less than all of the at least one aspect is decrypted in response to the member accessing the case.

9. The method of claim 1, further comprising generating a task list for each of the members in the directory and assigning the task list to each member in the directory, respectively.

10. The method of claim 1, wherein the step of creating the directory further comprises the steps of receiving, from the at least one secondary user, at least one credential, and if at least one of the at least one credentials is a requested credential, assigning the at least one secondary user as a member in the directory.

11. A case management system for sharing confidential files within a directory, comprising:
a processor;
a tangible, non-transitory memory configured to communicate with the processor, the tangible, non-transitory memory having instructions stored thereon that, in response to execution by the processor, cause the processor to perform the method comprising:
receiving identifying information associated with a first and at least one secondary user;
generating a profile for each of the first and at least one secondary user within a communication network system;
associating the profile for each of the first and at least one secondary user to members in the directory;
receiving case information from the member of the directory associated with the first user;
associating the case information with a case;
encrypting the case;
transmitting the case to the members in the directory; and
receiving at least one contribution to the case from any of the members in the directory;

12. The system of claim 11, wherein the directory further comprises a viewer user.

13. The system of claim 11, further comprising, by the processor, receiving from any member of the directory a request for information and responsive to receiving the request transmitting the request to another of the members in the directory.

14. The system of claim 11, wherein the step of encrypting the case utilizes end-to-end encryption.

15. The system of claim 10, wherein the case comprises at least one aspect related to a specific topic of the case.

16. The system of claim 15, wherein the at least one contribution is associated with any of the at least one aspects related to the specific topic of the case.

17. The system of claim 15, wherein any of the at least one aspect is encrypted separately from the case.

18. The system of claim 11, further comprising, by the processor, generating a task list for each of the members in the directory and assigning the task list to the associated member in the directory.

19. The system of claim 11, wherein the processor is further operative to selectively assign the at least one secondary user as a member in the directory by performing the steps of receiving, from the at least one secondary user, at least one credential and if the at least one credential is a requested credential, assigning the at least one secondary user as a member in the directory.
